(19) United States
(12) Patent Application Publication
(10) Pub. No.: US 2014/0026343 A1
(43) Pub. Date: Jan. 30, 2014

(54) Paint Roller

(71) Applicant: Daniel Perreault, Quebec City (CA)

(72) Inventor: Daniel Perreault, Quebec City (CA)

(21) Appl. No.: 13/950,496

(22) Filed: Jul. 25, 2013

(30) Foreign Application Priority Data
Jul. 28, 2012 (GB) 1213570.3

(51) Int. Cl. B05C 17/02

(52) U.S. Cl. CPC B05C 17/0217
USPC 15/230.11; 492/45

(57) ABSTRACT

A paint roller comprising: a frame; a roller cage assembly rotatably mounted to the frame; and a roller cover removably mountable to the roller cage assembly, the roller cover defining a roller cover passageway. The roller cage assembly includes a hub for mounting the roller cover thereonto, the hub defining a hub outermost surface insertable in the roller cover passageway and a locking mechanism for selectively locking the roller cover, the locking mechanism including a locking element movable between a locking position and a releasing position, the locking element defining a protruding portion. In the locking position, the protruding portion protrudes from the hub outermost surface. In the releasing position, the protruding portion is retracted inwardly relative to the hub outermost surface.

### FIELD OF THE INVENTION

The present invention relates generally to paint rollers and, more particularly, to a paint roller having a locking mechanism for locking a paint roller cover thereto.

### BACKGROUND

The prior art proposes numerous paint rollers provided with special means for securing the position of a roller cover onto the rotatable portion, also commonly known as the roller cage assembly, of the paint roller. These specially equipped paint rollers of the prior art have been designed to avoid a common annoying situation with conventional paint rollers wherein the roller cover has a tendency to gradually slip out of the roller cage assembly during a paint job.

While these prior art paint rollers can generally fulfill the main objective of preventing the roller cover from slipping out of the cage assembly, they also entail one or more of the following disadvantages. The paint rollers of the prior art generally become gradually inefficient for retaining a roller cover on their cage assembly as their retaining mechanism becomes more and more soaked in wet paint. Also, to engage or release a roller cover onto or from the roller cage assembly of these prior art paint rollers, the procedure is, in some instances, complex and/or non-intuitive to execute.

The paint rollers of the prior art also generally represent a complex assembly of multiple parts that are generally expensive to produce and/or assemble.

Against this background, there exist a need for an improved paint roller equipped with a roller cover locking mechanism that avoids the aforementioned disadvantages of the prior art.

It is a general object of the present invention to provide an improved paint roller.

### SUMMARY OF THE INVENTION

In a broad aspect, the invention provides a paint roller, the paint roller comprising: a frame; a roller cage assembly rotatably mounted to the frame; and a roller cover removably mountable to the roller cage assembly, the roller cover defining a roller cover passageway. The roller cage assembly includes a hub for mounting the roller cover thereonto, the hub defining a hub outermost surface insertable in the roller cover passageway and a locking mechanism for selectively locking the roller cover, the locking mechanism including a locking element movable between a locking position and a releasing position, the locking element defining a protruding portion. In the locking position, the protruding portion protrudes from the hub outermost surface. In the releasing position, the protruding portion is retracted inwardly relative to the hub outermost surface. With the roller cover mounted to the roller cage assembly, in the locking position, the protruding portion engages the roller cover to retain the roller cover; and in the releasing position, the protruding portion is retracted from the roller cover to allow removal of the roller cover from the roller cage assembly.

In some embodiments of the invention, an actuator is operatively coupled to the locking element for moving the locking element between the locking and releasing positions. In some embodiments of the invention, the locking element is biased towards the locking position.

In some embodiments of the invention, the roller cover defines a recess extending in the roller cover from the roller cover passageway, the recess receiving at least partially the protruding portion thereinto when the roller cover is mounted to the roller cage assembly and the locking element is in the locking position. For example, the recess extends circumferentially partially around the roller cover passageway. In another example, the recess is a substantially annular groove.

In some embodiments of the invention, the hub includes a hollow housing, the housing defining the hub outermost surface, the locking element being provided in the housing, the housing defining a housing aperture configured and sized for allowing the protruding portion to protrude therefrom.

In some embodiments of the invention, the housing defines substantially opposed housing first and second end walls and a housing peripheral wall extending therebetween, the housing aperture being provided in the housing peripheral wall.

In some embodiments of the invention, the locking element includes a locking element base movable between a base first position and a base second position, the locking element base being closer to the housing first end wall in the base first position than in the base second position; and an arm, the arm extending from the base and defining the protruding portion substantially opposed to the base, the arm being movable between an arm first position and an arm second position. In the releasing position, the base is in the base first position and the arm is in the arm first position. In the locking position, the base is in the base second position and the arm is in the arm second position.

In some embodiments of the invention, the frame includes an axle, the roller cage assembly being rotatably mounted to the axle, the axle extending through the housing between the housing first and second end walls; and the base is mounted to the axle so as to be movable substantially axially therealong.

In some embodiments of the invention, the locking mechanism includes a biasing element extending between the base and the housing first end wall, the biasing element biasing the base towards the base second position.

In some embodiments of the invention, the locking mechanism includes a push button extending through the housing second end wall and abutting against the base.

In some embodiments of the invention, the axle extends through the base.

In some embodiments of the invention, the arm is resiliently deformable between the arm first and second positions.

In some embodiments of the invention, the protruding portion defines a rounded tip. In other embodiments, the protruding portion defines a pointed tip.

In some embodiments of the invention, the roller cover passageway, the hub outermost surface, or both the roller cover passageway and the hub outermost surface are substantially cylindrical.

In some embodiments of the invention, the hub is a first hub, the roller cage assembly also including a second hub axially spaced apart from the first hub and a plurality of spring rods extending therebetween and frictionally engaging the roller cover when the roller cover is mounted to the roller cage assembly.

In another broad aspect, the invention provides a paint roller support for supporting a roller cover, the roller cover defining a roller cover passageway, the paint roller support comprising: a frame; a roller cage assembly rotatably mounted to the frame, the roller cover being removably mountable to the roller cage assembly; the roller cage assembly including a hub for mounting the roller cover thereonto, the hub defining a hub outermost surface insertable in the roller cover passageway and a locking mechanism for selectively locking the roller cover, the locking mechanism including a locking element movable between a locking position and a releasing position, the locking element defining a protruding portion. In the locking position, the protruding portion protrudes from the hub outermost surface; and in the releasing position, the protruding portion is retracted inwardly relative to the hub outermost surface. With the roller cover mounted to the roller cage assembly, in the locking position, the protruding portion engages the roller cover to retain the roller cover; and in the releasing position, protruding portion is retracted from the roller cover to allow removal of the roller cover from the roller cage assembly.

Advantageously, the proposed paint roller conveniently and securely prevents a roller cover from being longitudinally displaced, relative to the cage assembly, during use while being relatively inexpensive, robust and easy to manufacture.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates a paint roller in accordance with an embodiment of the present invention, here shown without a selectively lockable roller cover engaged on a roller cage assembly thereof;

FIG. 2, in a perspective, cross-sectional view, illustrates the paint roller shown in FIG. 1, here shown with a selectively lockable roller cover engaged on the roller cage assembly thereof;

FIGS. 3A to 3D, in a partial side cross-sectional view, illustrate an operational sequence in the use of a locking mechanism part of the paint roller shown in FIGS. 1 and 2 during a locking and a releasing operation the paint roller;

FIG. 4, in a partial side cross-sectional view, illustrates a method of manually blocking the rotation of a hub part of the paint roller shown in FIGS. 1 to 3D relative to the roller cover;

FIG. 5, in a perspective view, illustrates the roller cover shown in FIGS. 2 to 4;

FIG. 6, in a partial perspective view, illustrates an alternate embodiment of a protruding portion part of the locking mechanism of the paint roller; and

FIG. 7, in a side cross-sectional view, illustrates an alternate roller cover.

### DETAILED DESCRIPTION

In this document, the terminology “substantially” is used to denote variations in the thus qualified terms that have no significant effect on the principle of operation of the invention. These variations may be minor variations in design or variations due to mechanical tolerances in manufacturing and use of the various components of the invention. These variations and their effects are to be understood from the point of view of a person skilled in the art to which the present invention relates.

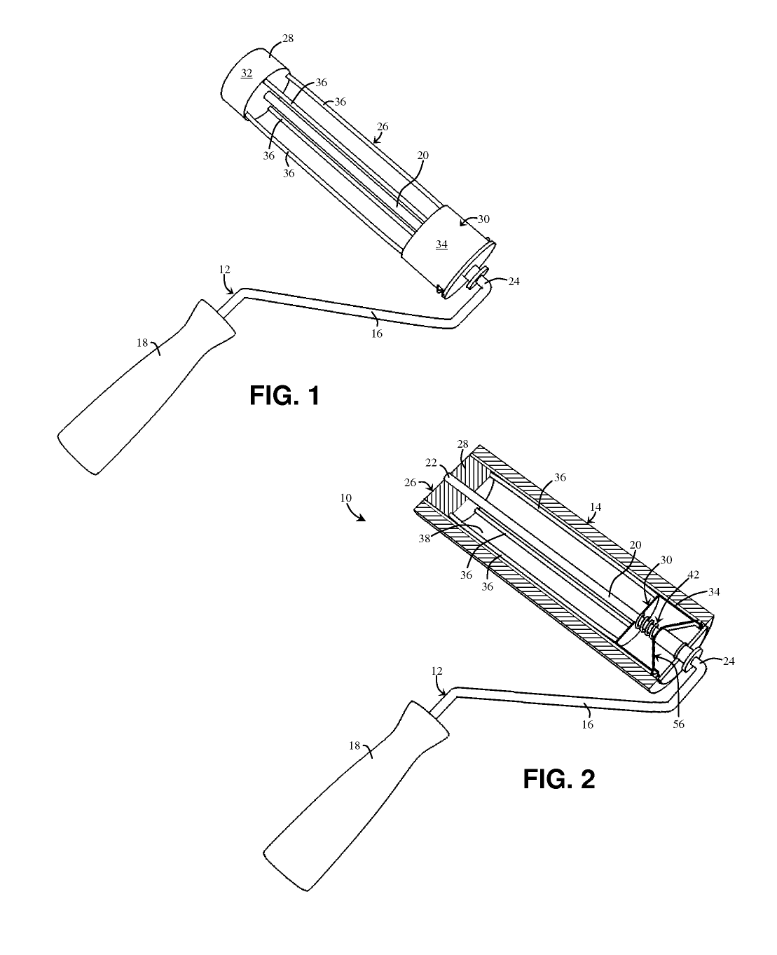

In FIGS. 1 to 5 show various aspects of an embodiment of a paint roller 10 in accordance with an embodiment of the present invention. Now referring more particularly to FIG. 2, the paint roller 10 generally includes a paint roller support 12 and at least one roller cover 14 (both shown assembled in a perspective cross-sectional view in FIG. 2). The paint roller support 12 includes a frame 16 and a roller cage assembly 26 rotatably mounted to the frame 16. The roller cover 14 is removably mountable to the roller cage assembly 26 and defines a roller cover passageway 38.

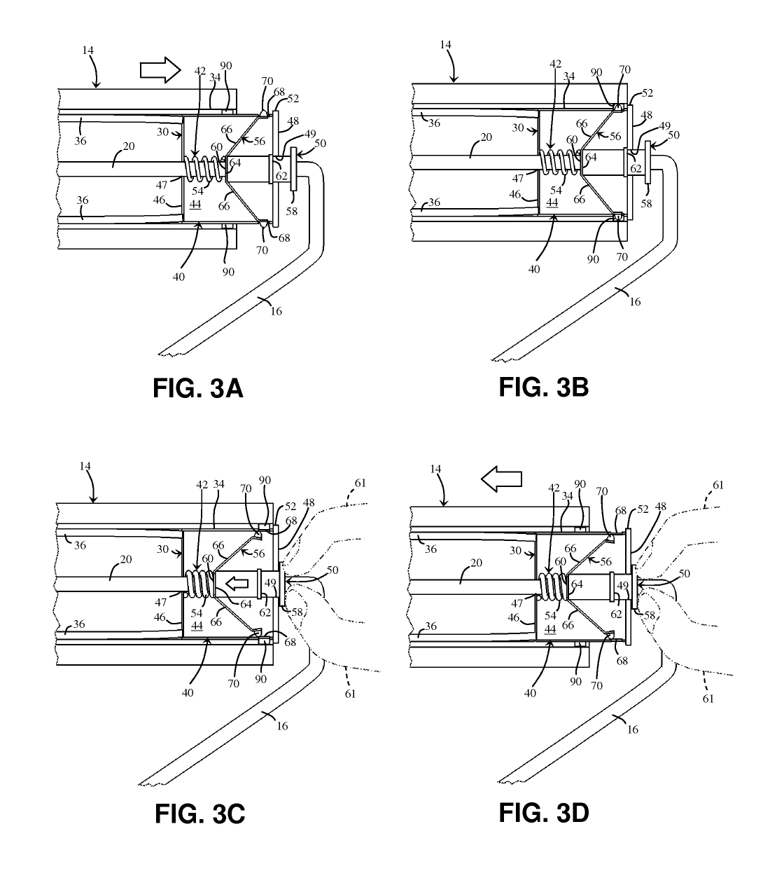

The roller cage assembly 26 including a first hub 30 for mounting the roller cover 14 thereonto, the first hub 30 defining a first hub outermost surface 34 insertable in the roller cover passageway 38 and a locking mechanism 42 for selectively locking the roller cover 14. The locking mechanism 42 includes a locking element 56 movable between a locking position (seen for example in FIG. 3B) and a releasing position (seen for example in FIG. 3C).

Referring for example to FIG. 3C, the locking element 56 defines a protruding portion 70. In the locking position, the protruding portion 70 protrudes from the first hub outermost surface 34. In the releasing position, the protruding portion 70 is retracted inwardly relative to the first hub outermost surface 34. With the roller cover 14 mounted to the roller cage assembly 26, in the locking position, the protruding portion 70 engages the roller cover 14 to retain the roller cover 14, and, in the releasing position, the protruding portion 70 is retracted from the roller cover 14 to allow removal of the roller cover 14 from the roller cage assembly 26.

Referring to FIG. 1, in a typical example of implementation, the frame 16 is a substantially conventionally sized and configured frame 16 represented by an elongated metal stem member having a substantially L-shaped configuration. The frame 16 is provided with a handle grip portion 18 at one end thereof, and a substantially rectilinear axle 20 at the other end thereof. The axle 20 is generally perpendicular to the handle grip portion 18 and defines an axle distal end 22 (seen in FIG. 2) and an axle proximal end 24 that is relatively closer to the handle grip portion 18 along the frame 16 than the axle distal end 22.

The roller cage assembly 26 is typically freely rotatably mounted on the axle 20, but other conventional possibilities for mounting the roller cage assembly 26 to the frame 16 are within the scope of the invention. The roller cage assembly 26 includes the first hub 30, and typically a second hub 28 axially spaced apart from the first hub 30. The first and second hubs 30 and 28 are typically substantially cylindrical. The second hub 28 is rotatably mounted substantially adjacent the axle distal end 22, and an first hub 30 is rotatably mounted substantially adjacent the axle proximal end 24.

The second hub 28 defines a second hub outermost surface 32. Typically, the first and second hub outermost surfaces 34 and 32 are both substantially cylindrical and have substantially identical outer diameters that are typically at least slightly smaller than the inner diameter of a standard size, conventional roller cover 14 that is commercially available.

The roller cage assembly 26 further includes a plurality, typically four (4), of elongated spring rods 36 extending between the first and second hubs 30 and 28 for at least slightly frictionally engaging the roller cover 14 in the roller cover passageway 38 when the roller cover 14 is mounted to the roller cage assembly 26. The elongated spring rods 36 are equidistantly radially disposed, in a substantially parallel fashion, with their ends rigidly coupled to oppositely facing, inner peripheral edge portions of the second and first hubs 28 and 30.

The roller cover passageway 38 typically extends through the roller cover 14 and is open at both ends thereof. Also, the roller cover passageway 38 is typically substantially cylindrical. However, in alternative embodiments, the roller cover passageway 38 extends only through a portion of the roller cover 14, and may therefore be closed at one end thereof. In addition, the roller cover passageway 38 may have any suitable shape complementary to the shape of the first and second hubs 30 and 28.

The roller cage assembly 26 may be rotatably retained axially along the axle 20 of the frame 16 in any conventional manner known in the art of assembly of conventional paint rollers. For example, a common manner is by pinching diametrically opposed portions of a metal stem forming the frame 16 in order to provide dimples or protrusions (not shown in the drawing for sake of simplicity) proximal the opposed ends of the second and first hubs 28 and 30. Other means for rotatably retaining the roller cage assembly 26 on the axle 20 are also possible.

In an alternate embodiment of a paint roller according to the present invention (not shown in the drawings), the elongated spring rods 36 are replaced with an integrally extending cylindrical surface between the second and first hub outermost surfaces 32 and 34. In other words, the second and first hubs 28 and 30 form a single elongated cylindrical hub member extending substantially the whole length of the axle 20 of the frame 16.

The second hub 28 may be conventionally represented by a filled or hollow cylindrical member made of a sufficiently rigid material such as, for example, a suitably rigid plastic or the like.

Now referring more particularly to FIGS. 3A to 3D inclusively, the first hub 30 includes a substantially hollow housing 40, which is typically cylindrical, that houses a locking mechanism 42 and defines the first hub outermost surface 34. As detailed hereinbelow, the locking element 56 is provided in the housing 40 and the housing 40 is configured and sized for allowing the protruding portion 70 to protrude therefrom.

Now referring more particularly to FIGS. 3A to 3D, the housing 40 defines substantially opposed housing first and second end walls 46 and 48 and a housing peripheral wall 44 extending therebetween. A housing aperture 68 is provided in the housing peripheral wall 44 for allowing movement of the protruding portion 70 therethrough.

The housing first end wall 46 defines a centrally disposed first end wall aperture 47 for freely rotatably receiving therethrough a portion of the axle 20. The housing second end wall 48 defines a centrally disposed second end wall aperture 49 having a diameter that is relatively larger than the first end wall aperture 47, for freely rotatably receiving therethrough an outer cylindrical surface portion of a substantially tube-shaped push button 50 of the locking mechanism 42, which is mounted to the axle 20 and will be described hereinafter.

Furthermore, in some embodiments, the housing 40 may be provided with a roller cover abutment ridge 52 projecting radially outwardly from a peripheral edge of the housing second end wall 48. The roller cover abutment ridge 52 is for abutting thereagainst the roller cover 14 when the latter is slidably engaged on the cylindrical housing 40. The housing 40 is typically made of the same material as the second hub 28.

The locking mechanism 42 typically includes an actuator operatively coupled to the locking element 56 for moving the locking element 56 between the locking and releasing positions. Also, the locking element 56 is typically biased towards the locking position.

For example, in the locking mechanism 42, the actuator includes a tube-shaped push button 50. Also, the locking mechanism includes a biasing element 54.

The tube-shaped push button 50 is for releasing the locking mechanism 42. The tube-shaped push button 50 is freely coaxially mounted on a portion of the axle 20 substantially proximal the axle proximal end 24. The tube-shaped push button 50 is movable axially along the axle 20 between a button first position, as illustrated in FIGS. 3A and 3B, and a button second position, as illustrated in FIGS. 3C and 3D.

The tube-shaped push button 50 extends through the housing second end wall 48 and defines a button outer end 58 projecting axially outwardly a relatively short distance from the housing second end wall 48. The button outer end 58 is suitably sized and configured for being axially pushed on inwardly towards the housing 40 by a user using one or more fingers 61, as illustrated in FIGS. 3C and 3D. The tube-shaped push button 50 further defines a button inner end 60 adapted for abutment against the locking element 56, and a travel-limiting member 62, here exemplified in the form of a ring protruding coaxially from a substantially mid-longitudinal portion of the tube-shaped push button 50. The travel-limiting member 62 limits the axial movement of the tube-shaped push button 50 towards the button first position.

The biasing element 54 is typically represented by an expansion coil spring freely coaxially mounted on the axle 20 and extending between the locking element 56 and the housing first end wall 46. The biasing element 54 is adapted for urging the locking element 56 and tube-shaped push button 50 towards the button first position. It is to be understood that other types of equivalent biasing element may be used such as, for example, a tube-shaped resilient member made of rubber, a rubbery polymer, or the likes.

The locking element 56 is for selectively locking the longitudinal axial movement of the roller cover 14 relative to the first hub 30 and, thus, relative to the axle 20 of the paint roller support 12.

The locking element 56 generally includes a base 64 and a least one arm 66. The axle 20 extends through the housing 40 between the housing first and second end walls 46 and 48 and the base 64 is mounted to the axle 20 so as to be movable substantially axially therealong. The base 64 is movable between a base first position and a base second position, the base 64 being closer to the housing first end wall 46 in the base first position than in the base second position. For example, the axle 20 extends through the base 64, which is substantially washer-shaped, and is coaxially mounted on the axle 20. The biasing element 54 extends between the base 64 and the housing first end wall 46 and biases the base 64 towards the base second position. Also, the push button 50 abuts against the base 64

The locking element 56 further generally includes a least one, but typically two (2), elongated arms 66. The arms 66 extend from the base 64 and define the protruding portion 70 substantially opposed to the base 64. Typically, the arms 66 extend integrally from the base 64, but in other embodiments, the arms 66 extend in any suitable other manner from the base 64. The arms 66 are movable between an arm first position and an arm second position. In the releasing position, the base is in the base first position and the arm is in the arm first position. In the locking position, the base is in the base second position and the arm is in the arm second position.

With the tube-shaped push button 50 at the button first position, the spring-biased arms 66 are projecting from the base 64 at a substantially oblique angle towards the housing apertures 68 provided through the housing peripheral wall 44, substantially adjacent the housing second end wall 48.

Each arm 66 is sized and configured such that its protruding portion 70 reaches substantially adjacent the corresponding housing aperture 68 and is spring-urged towards the housing peripheral wall 44. In some embodiments of the invention, the protruding portion 70 defines a rounded tip, as seen for example in FIGS. 3A to 3D. In other embodiments, as shown in FIG. 6, and alternative protruding portion 92 defines a pointed tip.

Each protruding portion 70 is sized and configured for freely slidably projecting through the housing aperture 68, and protrudes from the first hub outermost surface 34 a distance that is substantially equivalent to the thickness of an inner support tube 39 of the roller cover 14, which will be described further below.

Furthermore, the axial movement of the tube-shaped push button 50 along the axle 20, between the button first position, as illustrated in FIGS. 3A and 3B, and the button second position, as illustrated in FIGS. 3C and 3D, forces the protruding portion 70 to be pulled sufficiently inwardly to clear the housing peripheral wall 44 as the arm 66 is resiliently deformed between the arm first and second positions. To that effect, the locking element 56 is typically made out of a single piece of a suitably resilient, spring grade metal, particularly a spring grade steel.

Referring to FIG. 5, the roller cover 14 is typically sized, configured and made of similar materials as commercially available, conventional roller covers, e.g., a substantially elongated and cylindrically shaped inner support tube 39 generally made of sufficiently rigid cardboard or plastic material, and whose outer surface is covered with a roller cylindrical brush 37. The difference with the roller cover 14 of the present invention, relative to commercially available roller covers, resides in the presence of at least one, but typically a number equal to the number of arms 66, recess 90 extending in the roller cover 14 from the roller cover passageway 38. Each recess 90 receives at least partially a respective protruding portion 70 thereinto when the roller cover 14 is mounted to the roller cage assembly 26 and the locking element 56 is in the locking position. To that effect, the recesses 90 are sized, configured and positioned in register each with a respective housing aperture 68, when the roller cover 14 is slidably engaged thereon and abuts against the abutment ridge 52.

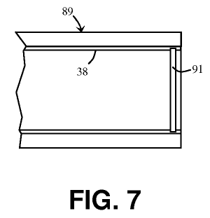

In some embodiments of the invention, the recess 90 extends circumferentially partially around the roller cover passageway 38. In other embodiments, as seen in FIG. 7 for the roller cover 89, the recess 91 is a substantially annular groove extending along the circumference of the roller cover passageway 38.

Thus, with the roller cover 14 engaged on the second hub 30, and the pair of protruding portions 70 protruding outwardly from the housing apertures 68 and engaged in the recesses 90 of the roller cover 14, these elements cooperatively form a lock for preventing the roller cover 14 from longitudinally axially moving from the roller cage assembly 26.

A mode of operation of the paint roller 10 is described in the following paragraphs. In a first step, the roller cover 14 has one end positioned in register with, and slidably engaged on, the roller cage assembly 26, with preferably the pair of recesses 90 of the roller cover 14 substantially aligned in register a respective one of the protruding portions 70 protruding from the housing peripheral wall 44, as illustrated in FIG. 3A.

In a second step, the roller cover 14 is further slidably engaged on the roller cage assembly 26 until its distal end firmly abuts against the abutment ridge 52 of the first hub 30, and the protruding portions 70 are positively engaged in their respective recesses 90.

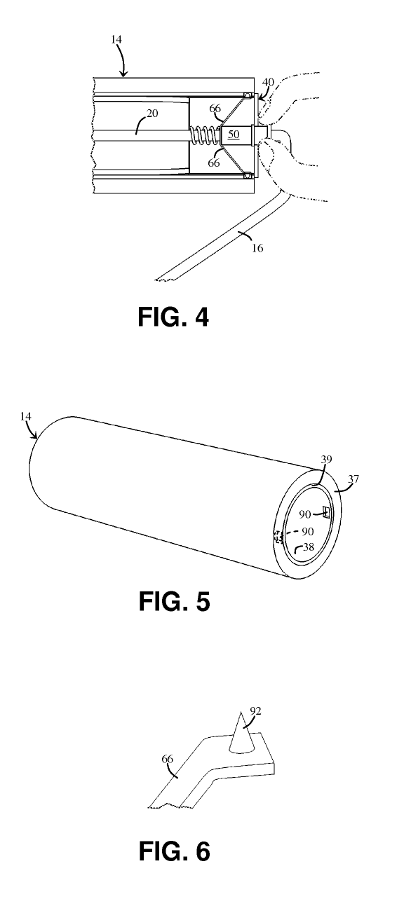

At this point, the user may verify if the roller cover 14 is well lockingly engaged thereon by trying to slide off the latter form the roller cage assembly 26. In the case in which the roller cover 14 is not locked to the roller cage assembly 26, because, for example, the protruding portions 70 are not properly aligned with the recesses 90 in the first place, the user may prevent the second hub 30 from rotating by pressing with two fingers between the housing second end wall 48 and the button outer end 58, as illustrated in FIG. 4. While the second hub 30 is thus prevented from rotating, the roller cover 14 may be rotated with the other hand until the protruding portions 70 positively engage with a their recess 90. Hence, the user may use the paint roller 10 in a conventional manner to paint a surface.

In a third step, for releasing the roller cover 14 from the paint roller support 12 in order to, for example, remove it for replacement with a new one, the user may push on the button outer end 58 with one or two fingers, as illustrated in FIG. 3C. By pressing on the button outer end 58, the tube-shaped push button 50 is moved from the outward button first position, to the inward button second position. By doing so, the arms 66 are pulled substantially laterally inwardly at an angle from the housing apertures 68 which, in turn, allows the roller cover 14 a free longitudinal axial movement towards the free end of the roller cage assembly 26.

In a fourth step, while maintaining the tube-shaped push button 50 thus pressed-on, the used roller cover 14 may be manually slid out from the roller cage assembly 26, as illustrated in FIG. 3D.

In a fifth step, the spring-biased tube-shaped push button 50 may be released, which reverts the latter back to the button first position and, thus to the initial configuration illustrated in FIG. 3A. A new roller cover 14 may then be engaged on the roller cage assembly 26 using the first and second steps described further above.

In an alternate embodiment of a paint roller according to the present invention, the latter includes more than the arms 66 and a corresponding number of housing apertures 68 through the housing peripheral wall 44, along with a corresponding number of recesses 90.

In another alternate embodiment of a paint roller according to the present invention, each protruding portion 70 is replaced with a substantially sharp-pointed protruding portion 92 as exemplified in FIG. 6. The sharp-pointed protruding portion 92 has a distal end that is sized and configured for sufficiently penetrating the inner cylindrical surface of a conventional roller cover 14, for retaining the latter at a fixed position relative to the first hub 30 during a painting operation. It is to be understood that other equivalent sharp-pointed elements than the one exemplified in the drawing may be used such as, for examples, a substantially triangularly-shaped blade, a substantially needle-shaped pin, or the likes. Thus, the paint roller support 12 of the present embodiment may be used with the roller cover 14, as well as with commercially available, conventional roller covers.

Although the present invention has been described hereinabove by way of preferred embodiments thereof, it can be modified, without departing from the spirit and nature of the subject invention as defined in the appended claims.

What is claimed is:

1. A paint roller, said paint roller comprising:
a frame;
a roller cage assembly rotatably mounted to said frame; and
a roller cover removably mountable to said roller cage assembly, said roller cover defining a roller cover passageway;
said roller cage assembly including a hub for mounting said roller cover thereonto, said hub defining a hub outermost surface insertable in said roller cover passageway; and a locking mechanism for selectively locking said roller cover, said locking mechanism including a locking element movable between a locking position and a releasing position, said locking element defining a protruding portion, wherein
in said locking position, said protruding portion protrudes from said hub outermost surface; and
in said releasing position, said protruding portion is retracted inwardly relative to said hub outermost surface;
whereby, with said roller cover mounted to said roller cage assembly,
in said locking position, said protruding portion engages said roller cover to retain said roller cover; and
in said releasing position, said protruding portion is retracted from said roller cover to allow removal of said roller cover from said roller cage assembly.

2. A paint roller as defined in claim 1, further comprising an actuator operatively coupled to said locking element for moving said locking element between said locking and releasing positions.

3. A paint roller as defined in claim 2, wherein said locking element is biased towards said locking position.

4. A paint roller as defined in claim 1, wherein said roller cover defines a recess extending in said roller cover from said roller cover passageway, said recess receiving at least partially said protruding portion thereinto when said roller cover is mounted to said roller cage assembly and said locking element is in said locking position.

5. A paint roller as defined in claim 4, wherein said recess extends circumferentially partially around said roller cover passageway.

6. A paint roller as defined in claim 4, wherein said recess includes a substantially annular groove.

7. A paint roller as defined in claim 1, wherein said hub includes a hollow housing, said housing defining said hub outermost surface, said locking element being provided in said housing, said housing defining a housing aperture configured and sized for allowing said protruding portion to protrude therefrom.

8. A paint roller as defined in claim 7, wherein said housing defines substantially opposed housing first and second end walls and a housing peripheral wall extending therebetween, said housing aperture being provided in said housing peripheral wall.

9. A paint roller as defined in claim 8, wherein said locking element includes
a locking element base movable between a base first position and a base second position, said locking element base being closer to said housing first end wall in said base first position than in said base second position;
an arm, said arm extending from said base and defining said protruding portion substantially opposed to said base, said arm being movable between an arm first position and an arm second position;
wherein
in said releasing position, said base is in said base first position and said arm is in said arm first position;
in said locking position, said base is in said base second position and said arm is in said arm second position.

10. A paint roller as defined in claim 9, wherein
said frame includes an axle, said roller cage assembly being rotatably mounted to said axle, said axle extending through said housing between said housing first and second end walls; and
said base is mounted to said axle so as to be movable substantially axially therealong.

11. A paint roller as defined in claim 10, wherein said locking mechanism includes a biasing element extending between said base and said housing first end wall, said biasing element biasing said base towards said base second position.

12. A paint roller as defined in claim 11, wherein said locking mechanism includes a push button extending through said housing second end wall and abutting against said base.

13. A paint roller as defined in claim 10, wherein said axle extends through said base.

14. A paint roller as defined in claim 9, wherein said arm is resiliently deformable between said arm first and second positions.

15. A paint roller as defined in claim 1, wherein said protruding portion defines a rounded tip.

16. A paint roller as defined in claim 1, wherein said protruding portion defines a pointed tip.

17. A paint roller as defined in claim 1, wherein said hub outermost surface is substantially cylindrical.

18. A paint roller as defined in claim 17, wherein said roller cover passageway is substantially cylindrical.

19. A paint roller as defined in claim 1, wherein said hub is a first hub, said roller cage assembly also including a second hub axially spaced apart from said first hub and a plurality of spring rods extending therebetween and frictionally engaging said roller cover when said roller cover is mounted to said roller cage assembly.

19. A paint roller support for supporting a roller cover, said roller cover defining a roller cover passageway, said paint roller support comprising:
a frame;
a roller cage assembly rotatably mounted to said frame, said roller cover being removably mountable to said roller cage assembly;
said roller cage assembly including a hub for mounting said roller cover thereonto, said hub defining a hub outermost surface insertable in said roller cover passageway and a locking mechanism for selectively locking said roller cover, said locking mechanism including a locking element movable between a locking position and a releasing position, said locking element defining a protruding portion, wherein
in said locking position, said protruding portion protrudes from said hub outermost surface; and
in said releasing position, said protruding portion is retracted inwardly relative to said hub outermost surface;
whereby, with said roller cover mounted to said roller cage assembly,
in said locking position, said protruding portion engages said roller cover to retain said roller cover; and
in said releasing position, said protruding portion is retracted from said roller cover to allow removal of said roller cover from said roller cage assembly.
